(19) United States
(12) Patent Application Publication
(10) Pub. No.: US 2003/0004974 A1
(43) Pub. Date: Jan. 2, 2003

(54) Configurable system monitoring for dynamic optimization of program execution

(76) Inventors: Hong Wang, Fremont, CA (US); Dong-Yuan Chen, Fremont, CA (US); John Shen, San Jose, CA (US); Wen-Hann Wang, Portland, OR (US); Oren Gershon, Rehovot (IL); Gadi Reuven Ziv, Haifa (IL)

Correspondence Address: Blakely, Sokoloff, Taylor & Zafman, 12400 Wilshire Boulevard, Seventh Floor, Los Angeles, CA, 90025-1030, US

(21) Appl. No.: 09/966,458

(22) Filed: Sep. 28, 2001

Related U.S. Application Data
(60) Provisional application No. 60/302,058, filed on Jun. 28, 2001.

(51) Int. Cl. G06F 12/00

(52) U.S. Cl. 707/200

(57) ABSTRACT

According to the invention, an apparatus and method are disclosed for configurable system monitoring for dynamic optimization of program execution. According to one embodiment, an event monitoring apparatus for dynamic optimization comprises an event monitor to capture profiles of events that occur in the processing of an application by a microprocessor; an interface to a software component; monitor control vectors to direct the operation of the event monitor; and a profile buffer. According to the embodiment, the events to be monitored are selected by the software component. Profiles of the selected events are captured and stored in the profile buffer. The profiles are made available to a handler routine selected by the software component, which processes the profiles to identify regions of the application for optimization and invokes optimizers to optimize the identified regions.

This application claims the benefit of U.S. Provisional Application No. 60/302,058, filed Jun. 28, 2001.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright® 2001, Intel Corporation, All Rights Reserved.

### FIELD OF THE INVENTION

This invention relates to computers in general, and more specifically to configurable system monitoring for dynamic optimization of program execution.

### BACKGROUND OF THE INVENTION

Dynamic optimization is an optimization mechanism by which the execution of a computer program is adapted to dynamic execution environment as affected by program inputs and the various states of the microprocessor. A dynamic optimizer continuously monitors the dynamic execution of a program over time and looks for areas in the program that can be adapted or modified to achieve better performance. Dynamic optimization is optimization that utilizes run-time information during program operation. Dynamic optimization can be contrasted with static optimization, which is based on program analysis instead of the data obtained during run-time. The process of monitoring, selecting regions for optimization, and performing the dynamic optimization cycle is typically performed totally in either hardware or software.

A trace cache mechanism in certain microprocessors is an example of conventional dynamic optimization accomplished using hardware. A trace is a record of the actions carried out by a computer system. In this example, a microprocessor continuously monitors the retired instruction stream from the execution pipeline and selectively places traces from the retired instruction stream in a linear cache to speed up future instruction fetch and decoding processes. A hardware monitor can monitor microarchitecture events that generally cannot be monitored by software alone.

However, hardware optimization of computer applications has limitations. By its nature, hardware is generally fixed and thus is difficult to modify and update. Further, conventional hardware optimization requires that additional work be done in the execution pipeline, thereby potentially slowing the computation process. In hardware optimization, a significant amount of logic is necessary even for simple optimization schemes. Sophisticated optimization is thus difficult to implement in hardware and may significantly increase the cost of hardware. Further, the data that is collected in conventional hardware optimization is isolated in the hardware and is not available for other uses.

In contrast, software optimization is easily implemented and is much simpler to modify and update in comparison with hardware optimization. For these reasons, software optimization may allow for more aggressive and sophisticated approaches to optimization. In a software dynamic optimizer, such as Dynamo of Hewlett Packard Corporation of Palo Alto, Calif., an interpreter may be used to execute the program initially, collecting the execution profile for the program as execution progresses and determining which region of the code is executed most often. Once the execution profile reaches a predetermined threshold, a frequently executed region of the program may be selected for optimization and be translated into a more efficient form. The dynamic optimized code is then used in future interpretation to improve program execution.

However, there are also disadvantages to conventional software optimization. Software optimization can create a bottleneck because of the overhead of implementing a software monitor. Further, in a software approach, the software can determine how many times certain regions of a program are executed, but generally cannot determine the real time costs of different operations and thus cannot accurately determine optimization needs.

### BRIEF DESCRIPTION OF THE DRAWINGS

The appended claims set forth the features of the invention with particularity. The invention, together with its advantages, may be best understood from the following detailed descriptions taken in conjunction with the accompanying drawings, of which:

FIG. 1 is a flow diagram illustrating an embodiment of hybrid dynamic optimization operations;

FIG. 2 is a diagram illustrating an embodiment of a hybrid dynamic optimizer;

FIG. 3 is a diagram illustrating an embodiment of a software component of a hybrid dynamic optimizer;

FIG. 4 is a diagram illustrating an embodiment of monitor control vectors;

FIG. 5 is a diagram illustrating an embodiment of a profile register file;

FIG. 6 is a diagram illustrating an embodiment of a profile backstore buffer; and

FIG. 7 illustrates an embodiment of a microprocessor execution pipeline.

### DETAILED DESCRIPTION

A method and apparatus are described for configurable system monitoring for dynamic optimization of program execution. A hybrid approach to dynamic optimization, in which both hardware and software optimization work together, offers advantages over conventional optimizers that are solely hardware or software based. In the hybrid approach, the advantages of hardware optimization, which can determine time costs more accurately and can monitor different types of events, and the advantages of software, which is easier to track and allows for more complex operation, are merged to provide a better dynamic optimization solution.

In the following description, for the purposes of explanation, numerous specific details are set forth in order to provide a thorough understanding of the present invention. However, it will be apparent to one skilled in the art that the present invention may be practiced without some of these specific details. In other instances, well-known structures and devices are shown in block diagram form.

The present invention includes various processes, which will be described below. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Terminology

Before describing an exemplary environment in which various embodiments of the present invention may be implemented, some terms that will be used throughout this application will briefly be defined:

As used herein, a “monitor” is a hardware device that measures electrical events, such as pulses or voltage levels, in a processor or computer, with measured events including microarchitecture events.

In this discussion, the term “optimization” is not limited to performance and achieving maximum speed, but is rather intended to indicate more general improvements in operation. A system may be optimized in many different ways depending on the motivations of the system programmer. The hybrid optimization method may, for example, be used if there is a need to slow down or throttle the operations of a system.

In this discussion, the term “event” means a processor microarchitecture event, including but not limited to instruction cache misses, retired branches, and other related events, and platform events, such as bus transactions.

In an embodiment of a hybrid hardware-software approach to dynamic optimization, hardware is employed to monitor dynamic program behavior and collect event profiles. Periodically a software component of the dynamic optimizer examines and processes the profiles that have been collected and identifies the program regions of interest that present a good opportunity for dynamic optimization (which may be referred to as “hot blocks”). A hybrid dynamic optimizer presents several advantages over purely hardware-based or software-based approaches. In a hybrid dynamic optimizer, the hardware monitor is able to monitor microarchitecture events that are not available to a software-based dynamic optimizer. Software-based region selection and optimization allows the implementation of more sophisticated optimizations that cannot be easily accomplished in a conventional hardware-based dynamic optimizer. In addition, with a hybrid approach, the types of events that are monitored and the profiles that are collected can be programmable in order to support varied needs and objectives.

In the hybrid dynamic optimization approach, the interaction between the hardware and the software determines the performance benefits that are achieved by optimization. A flexible interface to specify what events to monitor enables the software component of the hybrid dynamic optimizer to employ a wide and versatile array of optimization tools. A fast and efficient hardware profile collection mechanism allows the dynamic optimizer to adapt to changing program behavior quickly with minimal overhead. Further, a simple and efficient mechanism to transfer control between the hardware monitoring and profiling entity and the software optimizing entity provides a smooth transition between the hardware and software components of the optimizer.

Under one embodiment, the software component can choose types of events to be monitored by the hardware component. Under a particular embodiment, the events that are monitored include events that are associated with specific instructions and events that are global to the instruction pipeline. The hardware component includes a set of monitor control vectors that are programmed by the software component. The hardware monitor control vectors then control which events are monitored at what times. For example, based on selections made by the software component, a monitor control vector may direct that I-cache (instruction cache) miss events be monitored. Further, the monitor control vector may direct that the events be captured on a statistical sampling basis, such as capturing I-cache miss events every 1000 I-cache misses.

Under an embodiment, a microarchitectural technique is used to capture the pipeline event traces at very low cost in terms of the complexity of the design and the performance of the system. In this technique, the traces are initially stored in register files, which comprise a first level buffer, and then transferred to an architecturally visible mechanism in a memory buffer accessible by memory address, which comprises a second level buffer. When the memory buffer designated for a specified event is fully allocated or when some other condition specified by the software component exists, control is transferred to a handler routine through a lightweight interrupt mechanism. The handler routine processes the profile data and, upon finding code regions that will benefit from optimization, invokes appropriate optimizations for the regions of interest.

Under a specific embodiment of dynamic hybrid optimization involving a microprocessor containing an execution pipeline, an extension of the pipeline may be introduced at the exception detection (DET) and write-back (WRB) stages to filter the event instruction profile and to write the instruction profile into the profile register file. Under one embodiment, the microprocessor utilized is an Itanium® microprocessor of Intel Corporation of Santa Clara, Calif. However, embodiments are not limited to Itanium series microprocessors and may be implemented with other processors. In a particular embodiment of an Itanium series microprocessor, there is a dedicated stage for exception detection to detect exception conditions and invoke the architectural vector handler. For the execution pipeline of an Itanium microprocessor, this dedicated stage is responsible for performing predicate checker functionality to determine whether an executed instruction should be written back based on the resolved value of the predicate.

For a retired instruction, the write-back stage of an execution pipeline may be used to write back speculative values of destination registers into the architecturally visible register file. In an execution pipeline of an Itanium family microprocessor, where there are at least 5 or 6 registers for both source operands and destination operands per instruction, the existing data path to the register file is relatively wide and thus is particularly adaptable for saving profile information because such function may be accomplished without introducing new data paths.

Under an embodiment involving an Itanium microprocessor, a profile selection filtering logic may be introduced. Under a particular embodiment, the profile selection filtering logic is physically implemented as a predicate-like tag mask carried with an instruction. Under the embodiment, the mask vector is checked at the exception detection (DET) stage for profile legitimacy. If a profile is qualified for profile tracing, the profile of the instruction of concern is treated as an extra operand of the instruction, and, during the write-back stage, the profile is written back into the profile register file using the data path that already exists for the register access in the Itanium microprocessor. Depending upon specific implementation details, more information can be synthesized with the profile value of interest at the exception detection stage or write-back stage before the profile value is written into the profile register file.

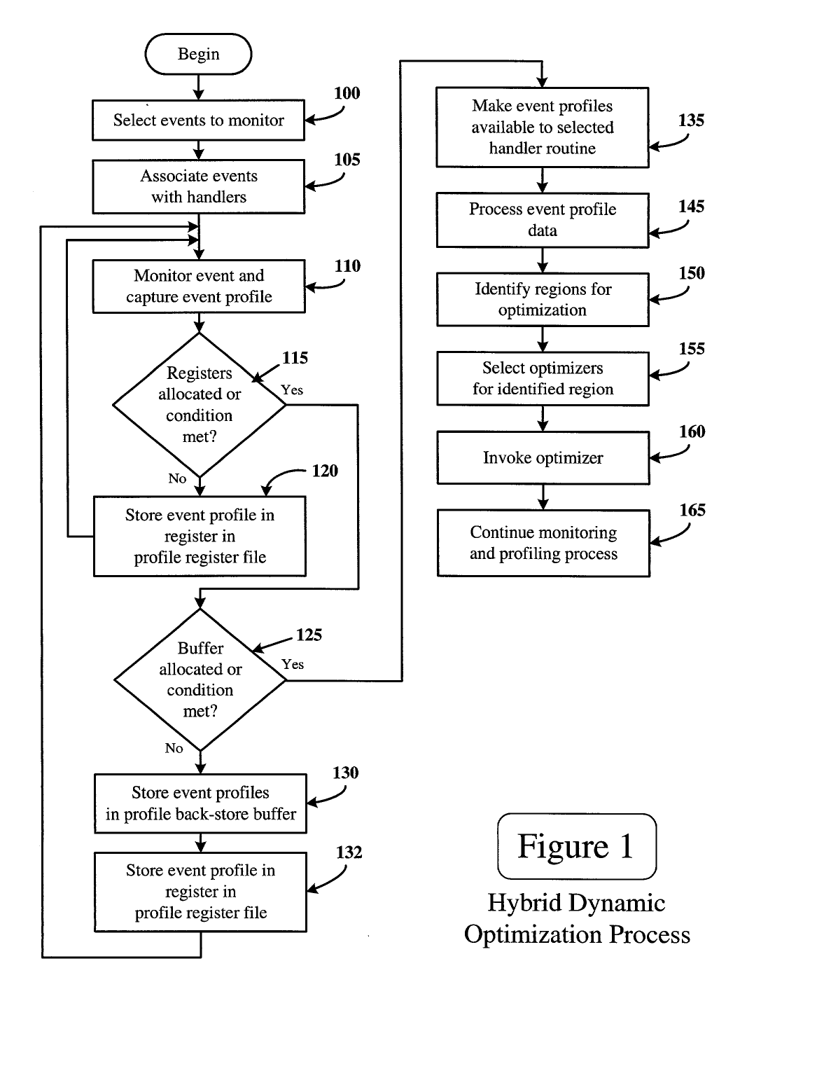

In the general application of dynamic hybrid optimization, FIG. 1 illustrates a flowchart of operations under an embodiment of a hybrid dynamic optimizer. Under this embodiment, the software component of the hybrid dynamic optimizer selects the events to monitor, process block 100. Upon selecting the events, the software component associates these events with handlers selected by the software component, process block 105. In the processing of an application, the event monitoring and profiling entity monitors the events and captures an event profile, process block 110.

In the embodiment shown in FIG. 1, the profile buffer for storing captured event profiles consists of two levels. The first level profile buffer is a profile register file, comprising a frame for each event being monitored. The second level profile buffer is a profile backstore buffer, comprising one memory buffer for each event being monitored. When an event profile is captured, there is a determination whether the registers within the frame for the event are fully allocated or another condition set by the software component is met, process block 115. In one embodiment, the microprocessor may proactively spill the content of an event profile frame into the appropriate memory buffer within the profile backstore buffer when sufficient memory space is available, thereby maintaining available register space and allowing the microprocessor to continue writing without encountering delay when the all registers in the event profile frame are allocated. A determination whether the registers are fully allocated may be conducted in parallel with other determinations if proactive spilling is enabled. If the registers in the frame are not fully allocated and no other established condition is not met, the captured event profile is stored in a register in the appropriate frame within the profile register file, process block 120, and the process continues with the capturing of event profiles, process block 110. If the frame registers of the event are fully allocated or another condition is met, there is a determination whether the memory buffer for the event in the profile backstore buffer is fully allocated or some other established condition is met, process block 125. If the memory buffer is not fully allocated and no other condition is met, the event profiles currently contained in the frame are stored in the profile backstore buffer, process block 130, and the new event profile is stored in the frame registers for the event, process block 132. The process then continues with the capturing of event profiles, process block 110.

If the memory buffer for the event is fully allocated or another condition is met, the stored event profiles are made available to the handler specified by the software component, process block 135, via an interrupt or special event handler sent to the specified handler. In one embodiment, the profile backstore buffer is architecturally visible to the software component, and is therefore programmable. The handler selected by the software component processes the event profile data, process block 145, and identifies a region of interest for optimization, process block 150. The software component selects an optimizer for the identified region of interest, process block 155, and the optimizer is invoked, process block 160, to optimize the operation of the region of interest. As stated above, the optimization may involve optimizing the speed of operation of the region of interest or may involve one or more different optimization goals. The system then may continue the monitoring and profiling process, process block 165.

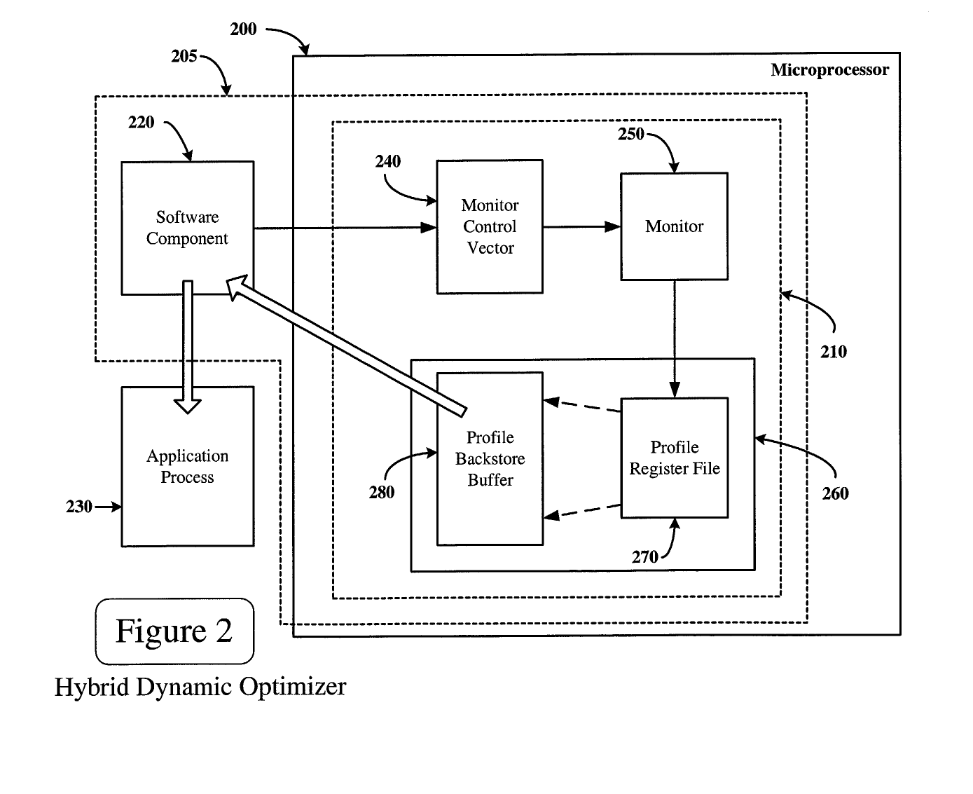

An embodiment of a hybrid dynamic optimization system 205 is illustrated in FIG. 2. In FIG. 2, the hybrid dynamic optimization system 205 includes an event monitoring and profiling portion 210 of a microprocessor 200. In addition, the hybrid dynamic optimization system 205 includes a software component 220. Microprocessor 200 runs an application process 230 that is subject to optimization. Thus, the system provides a software component that is interfaced with a hardware component to accomplish dynamic optimization. The hybrid dynamic optimization system 205 continuously monitors the execution of application process 230 and applies dynamic optimization to improve the performance of the application when optimization opportunities are identified.

In FIG. 2, the event monitoring and profiling entity 210 contains a number of monitor control vectors 240, which are configurable by the software component 220. In this manner, the monitor control vectors 240 control the capture and storage of data regarding the processor events to be monitored using the process monitor 250. Events that are monitored may be events associated with specific instructions or may be events that are global to the pipeline. When an event profile is captured, the profile is stored in the appropriate frame of a profile register file 270, which is the first level of profile buffer 260. When the frame in the profile register file for an event is fully allocated or another condition set by the software component is met, the captured profiles are transferred to a memory buffer for the event in a profile backstore buffer 280, the second level of profile buffer 260. In one embodiment, microprocessor 200 may also proactively spill the contents of the event profile frame into the appropriate memory buffer within the profile backstore buffer 280 when sufficient memory space is available. When the memory buffer for the event in profile backstore buffer 280 is fully allocated or another condition established by the software component is met, a notification is sent to the handler specified by the software component 220. As more fully explained below, the turn around time for a handler routine to process data in the profile backstore buffer may be reduced by making an empty memory buffer available to the microprocessor when an event handler routine begins operation. In one embodiment, profile backstore buffer 280 is architecturally visible to software component 220. Software component 220 processes the event profile data and identifies regions of interest in application process 230 that may be optimized.

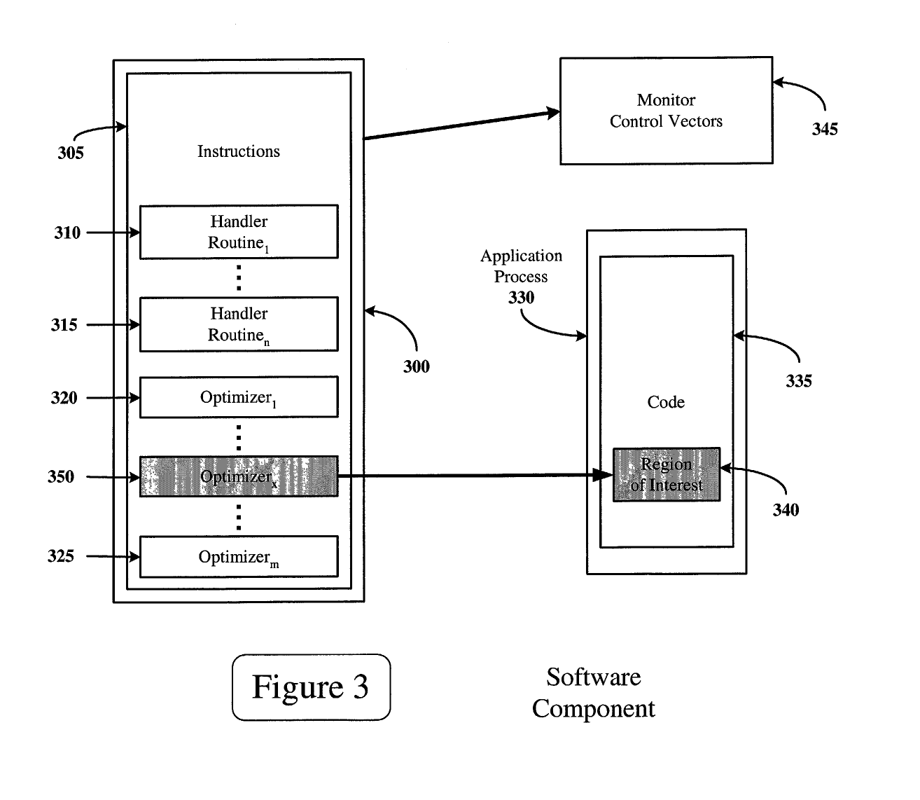

FIG. 3 illustrates a software component of a hybrid dynamic optimizer under a particular embodiment. In the illustration, software component 300 is optimizing an application process 330. For the purposes of this illustration, application process 330 is shown to contain code 335. The instructions 305 contained in software component 300 include handler routines, shown in FIG. 3 as handler routine₁ 310 through handler routineₙ 315, and optimizers, shown in FIG. 3 as optimizer₁ 320 through optimizerₘ 325. Each handler routine contains instructions for processing monitor event profiles and coordinating with respect to the information contained in the profile for an event. If handler routine₁ 310 is the handler routine for a monitored event, a pointer to the handler routine is stored in a field in one of the monitor control vectors 345. Further details regarding exemplary monitor control vectors are discussed below.

Based at least in part on captured event profiles, software component 300 will attempt to identify regions of interest for optimization in code 335 of application process 330. In FIG. 3, for example, a region of interest 340 is identified. Upon identifying region of interest 340, software component 300 will select the appropriate optimizer. In FIG. 3, optimizerₓ 350 is selected and is invoked to optimize region of interest 340. As indicated above, optimization of a region of interest may take various forms and is not limited to increasing the speed of operation of regions of interest.

Under one embodiment, each monitor control vector includes a number of fields to control the monitoring of an event. For example, a control field in each monitor control vector controls may specify the type of events to monitor and other relevant parameters. A trigger field in a monitor control vector may specify when a given event should be monitored. Further, a handler field in each monitor control vector may contain a function pointer to a handler routine in the software component for the processing of captured event profile data.

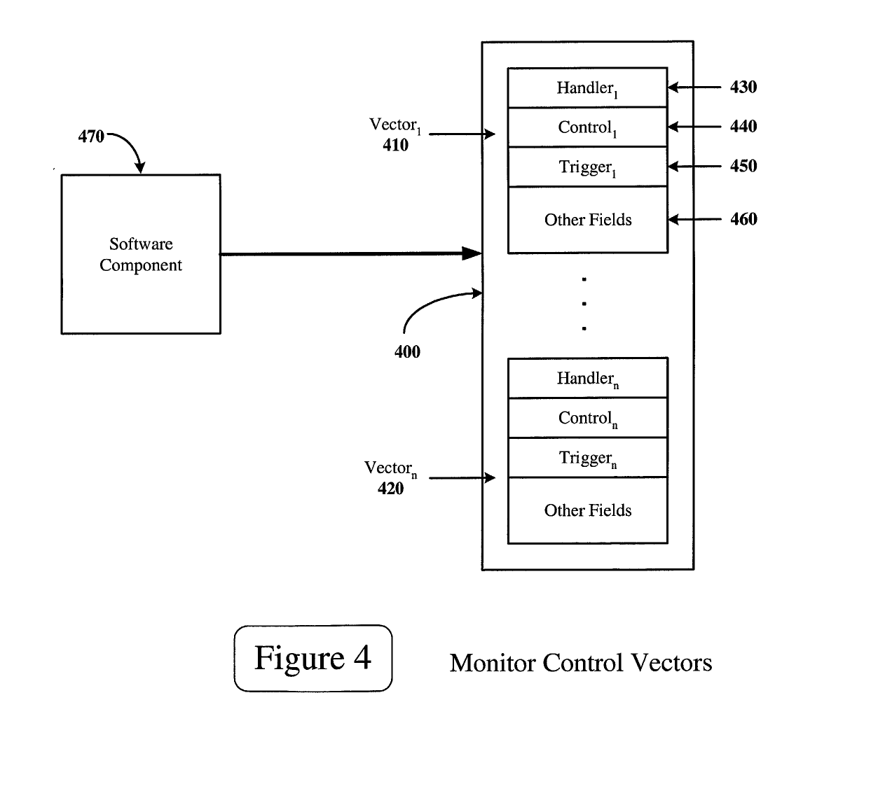

Details regarding an embodiment of monitor control vectors are illustrated in FIG. 4. In a particular embodiment, the monitor control vectors 400 include vector₁ 410 through vectorₙ 420. Each vector is comprised of a number of different fields. For example, the fields within vector₁ 410 include a handler field, handler₁ 430, a control field, control₁ 440, and a trigger field, trigger₁ 450, in addition to any other fields 460. Other fields may include fields indicating the location and size of the profile register file or the address of the profile backstore buffer. In this illustration, handler₁ 430 will contain a pointer to a handler routine in the software component 470. Control₁ 440 contains data regarding what type of event will be monitored by vector₁ 410. Trigger₁ 450 contains data regarding when the specified type of event will be captured.

A handler routine processes the captured event profile data regarding a specific type of event to identify promising regions for optimizations and selects an optimization method. Once the handler routine has chosen an optimization method, the handler routine invokes the appropriate optimizer from the optimizers available to perform the task and eventually links the optimized code with the execution image of the application process. In general, the handler routines reside in the OS (operating system) kernal space, similar to a device driver, while the optimizers reside in an application process. However, embodiments are not limited to this structure and components may be stored in different locations.

Based upon the directions of the monitor control vectors, profiles of events are captured by a hardware monitor. Once the event profiles are captured, the data is stored in a profile buffer. According to one embodiment, the profile buffer is comprised of two levels, a first level profile register file and a second level profile backstore buffer.

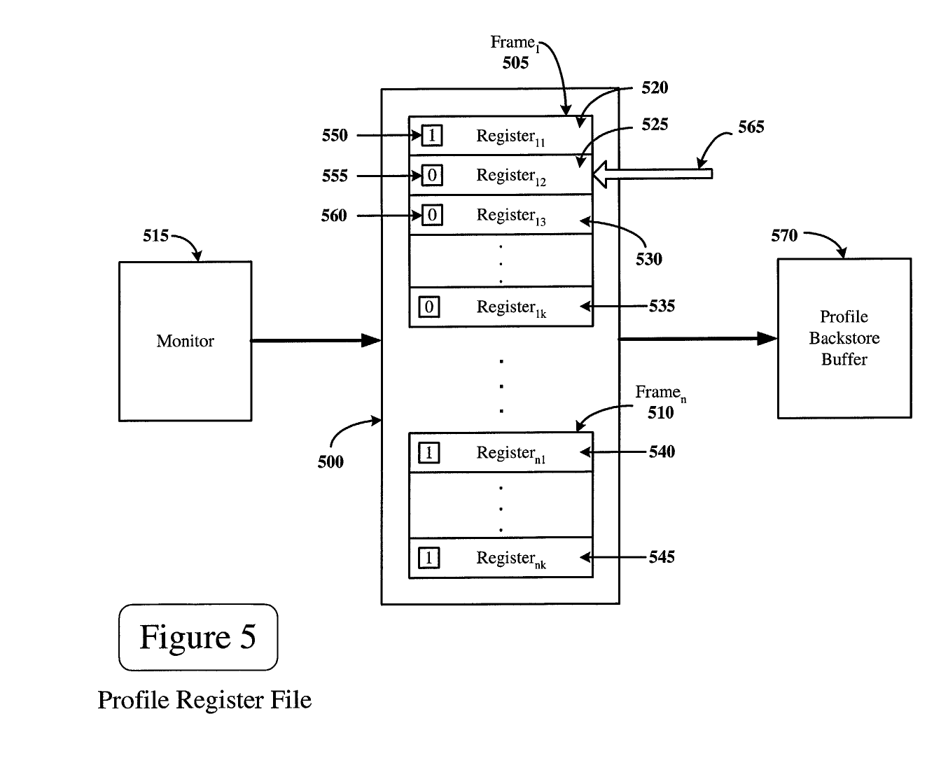

In FIG. 5, an embodiment of a profile register file is illustrated. Profile register file 500 is the first level profile buffer. As a first level buffer, profile register file 500 is a small and fast register for the initial storage of event profile data. Profile register file 500 contains a plurality of frames, each frame being for the storage of event profiles captured by monitor 515 for a particular event. In FIG. 5, profile register file 500 contains n frames, the frames being frame₁ 505 through frameₙ 510. Note that the separate frames shown are based on a logical view of the profile register file and are not necessarily physically separated. The frames may be included within a single physical register file. Each frame in profile register file 500 can contain a certain number of registers for event profiles, which for this illustration is shown as k event profile registers for each event frame. Therefore, frame₁ 505 contains event profile register₁₁ 520 through event profile register₁ₖ 535, while frameₙ 510 contains event profile registersₙ₁ 540 through event profile registerₙₖ 545. When any frame has k event profiles stored, k being the maximum number of event profiles that may be stored in the frame, the stored event profiles are transferred to profile backstore buffer 570, the second level buffer for storage of event profiles. As indicated above, in certain embodiments event profiles may also be proactively spilled to profile backstore buffer 570, thereby maintaining available register space and reducing microprocessor delays. After event profiles stored in a frame have been spilled over to the profile backstore buffer 570, the frame may then again be used to store an additional k event profiles as such event profiles are captured.

In the embodiment shown in FIG. 5, each register has a bit indicating that the register is in use. In one example, event profile register₁₁ has used bit 550. In this example, used bit 550 contains a “1”, which indicates that event profile register₁₁ 520 in frame₁ 505 is currently in use. A current frame position pointer 565 points to the next register in frame₁ 505 that is currently not used, which is event profile register₁₂ 525 as used bit 555 for event profile register₁₂ 525 contains a “0”. When another event profile is captured, the profile data is stored in event profile register₁₂ 525 and current frame position pointer 565 is updated to point to the next register in frame₁ 505 that is currently not in use, which in this particular example then would be event profile register₁₃ 530 as used bit 560 contains a “0”. When the profile registers in a frame are spilled into profile backstore buffer 570, then the used bits in the profile registers are reset to indicate that the registers are available for storage.

In one embodiment, a spill position pointer (not shown in FIG. 5) is also maintained in each frame of profile register file 500 to indicate the next register to be written to the profile backstore buffer 570. Once the content of the designated register is spilled into profile backstore buffer 570, then the spill position pointer is updated to point to the next register to be spilled and the used bit in the spilled register is reset. Further, under one embodiment, profile register file 500 is not made architecturally visible because profile backstore buffer 570 is architecturally visible and thus the captured event profile data can be obtained by the software component by accessing profile backstore buffer 570. Note that under a particular embodiment the current frame position pointer and spill position pointer can be made architecturally visible by storing such pointers as part of the monitor control vector.

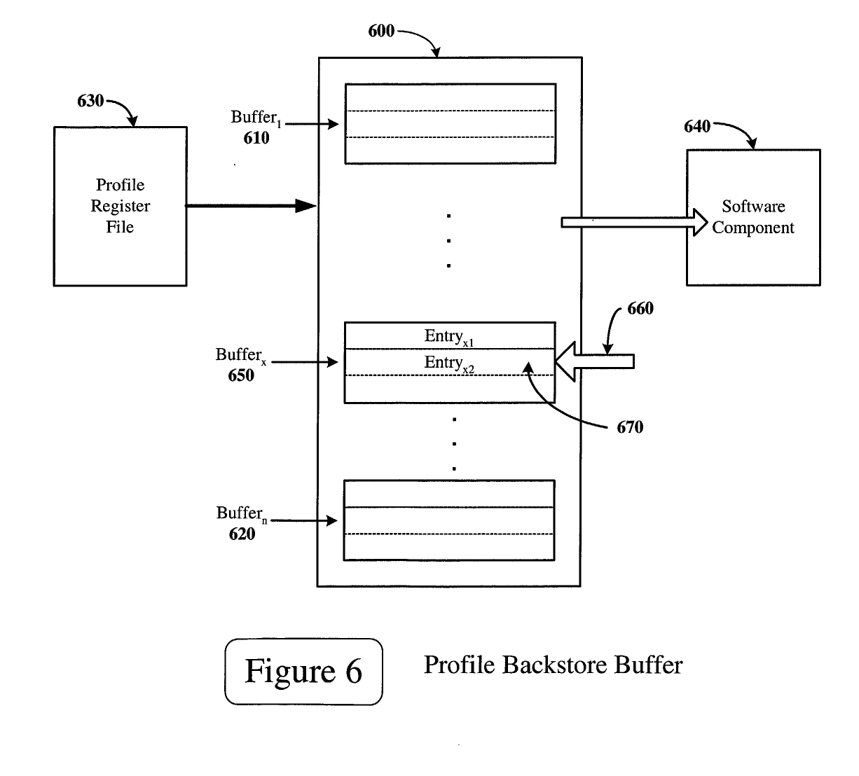

FIG. 6 shows an embodiment of a profile backstore buffer. As the second level buffer in the profile buffer, profile backstore buffer 600 receives event profiles from the first level buffer, profile register file 630. Under a particular embodiment, profile backstore buffer 600 is a linear buffer with one buffer for each monitor control vector, but an arrangement as a linear buffer is not required. In FIG. 6, profile backstore buffer contains n memory buffers denoted as buffer₁ 610 through bufferₙ 620. Under one embodiment, when a memory buffer in profile backstore buffer 600 is fully allocated and contains the maximum number of event profiles that may be stored or when another condition set by the software component is met, the handler selected by software component 640 is notified by a lightweight interrupt or special event handler and the appropriate handler routine in the software component 640 processes the event profiles stored in the memory buffer to identify regions of interest for optimization. Within each memory buffer, the next available address for storage is indexed by a current buffer position pointer. For example, in bufferₓ 650, the next available pointer 660 points to entryₓ₂ 670 and the next event profile to be written to bufferₓ 650 will be written to entryₓ₂ 670. Upon data being stored in entryₓ₂ 670, next available pointer 660 will be updated to point to the next available register. Under certain embodiments, the next available pointer is made architecturally visible and therefore is programmable.

Under an another embodiment, a buffering mechanism is utilized to reduce the turn around time for a handler routine to process data in the event profile buffer. According to the embodiment, when a memory buffer is fully allocated and an event handler routine begins operation, an empty buffer is made available to the microprocessor to begin storing new captured profile data. For example, the handler routine may notify the microprocessor regarding the starting address and size of the empty memory buffer to be used for the event, such that the collection of event profiles can continue while the previously collected data is processed.

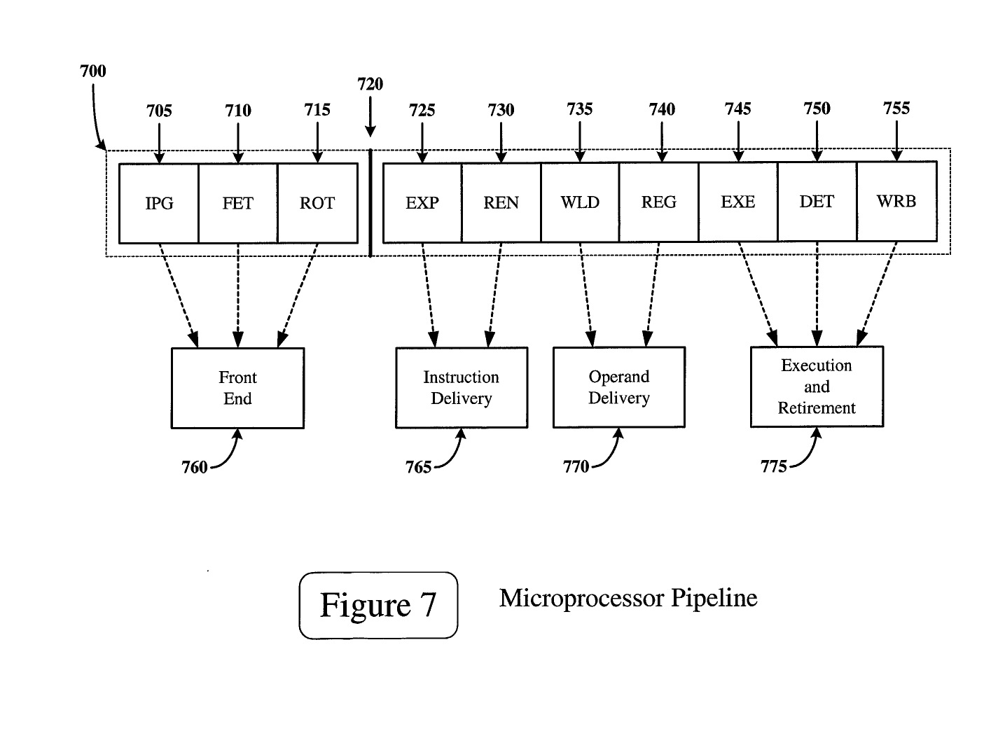

FIG. 7 illustrates an embodiment of an execution pipeline of a microprocessor that may be utilized in a particular embodiment of hybrid dynamic optimization. The execution pipeline embodiment illustrated is derived from the Itanium series microprocessors of Intel Corporation, but the concepts presented are not limited to this particular family of microprocessors. The execution pipeline 700 includes ten stages. The first three stages of the execution pipeline 700 make up the front end 760 of the pipeline. The front end stages are the IPG (instruction pointer generation) 705, FET (fetch) 710, and ROT (instruction rotation) 715 stages, which perform the functions of fetching an instruction and delivering the instruction to a decoupling buffer in the ROT 715 stage that allows the front-end 760 of execution pipeline 700 to operate independently from the remainder of the pipeline. The point of decoupling 720 is illustrated by the line separating the stages of the pipeline. Dispersal and register renaming are performed in the EXP (expand) 725 and REN (rename) 730 stages, which make up the instruction delivery portion 765 of execution pipeline 700. The functions of the operand delivery portion 770 of execution pipeline 700 are performed in the WLD (wordline decode) 735 and REG (register read) 740 stages, which provide for accessing register files and delivering data through the bypass network after processing predicate control. The last three stages of execution pipeline 700, EXE (execute) 745, DET (exception detection) 750, and WRB (write-back) 755, form the execution and retirement portion 775 and perform wide parallel execution, exception management, and retirement. The DET stage 750 accommodates delayed branch execution as well as memory exception management and speculation support. As discussed above, the structure of the DET 750 and WRB 755 stages of the pipeline allows these stages to be utilized in embodiments of hybrid dynamic optimization. However, hybrid dynamic optimization is not limited to these stages and other embodiments are possible.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An event monitoring component for dynamic optimization comprising:
an event monitor to selectively capture profiles of one or more microarchitecture events occurring in the execution of an application by a microprocessor based upon configuration information supplied by a software component; and
an interface through which the software component provides the configuration information to direct the operation of the event monitor.

2. The event monitoring component of claim 1, further comprising:
one or more monitor control vectors, the monitor control vectors storing the configuration information provided by the software component.

3. The event monitoring component of claim 2, wherein each monitor control vector includes:
a control field to specify a microarchitecture event to monitor;
a handler field, the handler field containing a pointer to a handler routine to process the profiles of the microarchitecture event; and
a trigger field to specify when the microarchitecture event is monitored.

4. The event monitoring component of claim 1, further comprising:
a profile buffer to store the captured profiles of the one or more microarchitecture events.

5. The event monitoring component of claim 4, wherein the profile buffer comprises a first level buffer for initial storage of the captured profiles of the one or more microarchitecture events and a second level buffer for subsequent storage of the captured profiles of the one or more microarchitecture events.

6. The event monitoring component of claim 5, wherein the first level buffer is a register file.

7. The event monitoring apparatus of claim 5, wherein the second level buffer is a memory buffer that is architecturally visible to the software component.

8. The event monitoring apparatus of claim 1, wherein the captured event profiles of each monitored microarchitecture events are made available to a handler routine selected by the software component for processing.

9. The event monitoring apparatus of claim 1, wherein the event monitoring apparatus initiates an interrupt or special event handler to notify the software component when captured event profiles are available for processing.

10. A microprocessor, comprising:
an execution pipeline;
one or more event monitors coupled to the execution pipeline to selectively monitor one or more microarchitecture events in the execution of a program and to capture event profiles;
one or more monitor control vectors to store configuration information provided by a software component in connection with the operation of the one or more event monitors; and
a profile buffer to store captured microarchitecture event profiles.

11. The microprocessor of claim 10, wherein the captured profiles of the one or more microarchitecture events stored in the buffer are made available to a handler routine selected by the software component for optimization processing.

12. The microprocessor of claim 11, wherein the profile buffer comprises a first level buffer for initial storage of the captured microarchitecture event profiles and a second level buffer for subsequent storage of the captured microarchitecture event profiles.

13. The microprocessor of claim 12, wherein the first level buffer is a register file.

14. The microprocessor of claim 13, wherein the second level buffer is a memory buffer that is architecturally visible to the software component.

15. The microprocessor of claim 14, wherein the first level buffer is comprised of a plurality of register frames and the second level buffer is comprised of a plurality of memory buffers, with one of the frames of the first level buffer and one of the memory buffers in the second level buffer being assigned to each monitored microarchitecture event.

16. The microprocessor of claim 15, wherein the profiles of a microarchitecture event stored in a frame assigned to the microarchitecture event in the first level buffer memory are spilled into a buffer assigned to the microarchitecture event in the second level memory buffer when the frame assigned to the microarchitecture event in the first level memory buffer is fully allocated or when a condition established by the software component is met.

17. The microprocessor of claim 16, wherein the captured profiles of a microarchitecture event are made available to the handler routine when the buffer assigned to the event in the second level memory buffer is fully allocated or when a condition established by the software component is met.

18. The microprocessor of claim 10, wherein each of the monitor control vectors includes:
a control field to specify a microarchitecture event to monitor;
a handler field, the handler field containing a pointer to a handler routine for the microarchitecture event; and
a trigger field to specify when the microarchitecture event is monitored.

19. The microprocessor of claim 10, wherein the one or more microarchitecture events are monitored during an exception detection stage of the execution pipeline.

20. The microprocessor of claim 10, wherein the captured microarchitecture event profiles are stored in the memory buffer during a write back stage of the execution pipeline.

21. A method comprising:
receiving configuration information from a software component directing the monitoring of one or more microarchitecture events connected with the operation of a microprocessor in executing an application;
monitoring the one or more microarchitecture events and capturing profiles of the one or more microarchitecture events;
storing the captured event profiles in a profile buffer; and
making the profiles of the event available to the software component for optimization processing.

22. The method of claim 21, wherein receiving the configuration information from the software component comprises receiving information regarding the setting of one or more monitor control vectors.

23. The method of claim 22, wherein each monitor control vector includes at least the following fields:
a control field to specify the microarchitecture event to monitor;
a handler field, the handler field containing a pointer to a handler routine for processing of captured profiles of the microarchitecture event; and
a trigger field to specify when the microarchitecture event is monitored.

24. The method of claim 21, wherein the profile buffer is comprised of a first stage for initial storage of the captured profiles of the one or more microarchitecture events and a second stage for subsequent storage of the captured profiles of the one or more microarchitecture events.

25. The event monitoring component of claim 24, wherein the first stage is a register file.

26. The processor of claim 25, wherein the second stage of the profile buffer is a memory architecturally visible to the software component.

27. The method of claim 26, further comprising assigning a register in the first stage and a memory buffer in the second stage to each monitored microarchitecture event.

28. The method of claim 27, further comprising storing the profiles of each monitored microarchitecture event in the register assigned to the microarchitecture event in the first stage as the profiles of the microarchitecture event are captured.

29. The method of claim 27, further comprising spilling the profiles of a microarchitecture event from the register assigned to the microarchitecture event in the first stage to the memory buffer assigned to the microarchitecture event in the second stage when the register is fully allocated or when a condition established by the software component is met.

30. The method of claim 29, further comprising notifying the software component when the register assigned to the event in the second stage of the memory buffer is fully allocated or when a condition established by the software component is met.
